(19) United States
(12) Patent Application Publication
(10) Pub. No.: US 2008/0164715 A1
(43) Pub. Date: Jul. 10, 2008

(54) Mounting Device for A Vehicle Interior Component

(76) Inventors: Frederic Selvini, Falck (FR); Andre Nyznyk, Ham Sous Varsberg (FR)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/908,512

(22) PCT Filed: Mar. 16, 2006
(86) PCT No.: PCT/EP2006/060811

§ 371 Date: Dec. 6, 2007

(30) Foreign Application Priority Data
Mar. 17, 2005 (DE) 10 2005 012 860.2

(51) Int. Cl. B60J 3/02

(52) U.S. Cl. 296/97.13

(57) ABSTRACT

The invention relates to a fixing device for a vehicle for mounting a component, especially a sun visor. The fixing device comprises a cantilever arm that can be pivoted about a first, especially vertical rotational axis but is fixed in relation to the vehicle body. The component can be tilted in relation to the cantilever arm about a second, especially horizontal rotational axis. In addition to the fact that the component can be tilted about the second rotational axis, the position of the component can be modified in relation to the cantilever arm.

### CROSS REFERENCE TO RELATED APPLICATIONS

None.

### BACKGROUND OF THE INVENTION

1. Field of the Invention

The present invention relates to a mounting or fixing device for a vehicle for fixing a component, especially a sun visor, the fixing device comprising a cantilever arm which may be pivoted about a first, especially vertical rotational axis but is otherwise fixed in relation to the vehicle body, the component being able to be tilted in relation to the cantilever arm about a second, especially horizontal rotational axis. The present invention further relates to the component, especially a sun visor.

2. Related Art

Sun visors are frequently used in vehicles as sun protection for the passengers.

The publication DE 200 12 488 U1 discloses a sun visor for a vehicle with an L-shaped retaining means, the retaining means being rotatably mounted on the vehicle roof about a vertical axis and being arranged on a corner of the sunshade surface. The sunshade surface may be tilted from a position in which it is arranged parallel to the vehicle roof, into a position arranged substantially vertically and transversely to the direction of travel. By rotating about the vertical axis, said sunshade surface may be rotated such that it extends in the direction of travel. The sun visor comprises one or more additional visors by means of which the surface to be protected may be enlarged when the sunshade surface is tilted in the vertical direction.

The publication DE 101 53 153 A1 discloses a sun visor comprising a bearing block which may be rotated about a vertical axis, on which a projecting retainer is arranged. On the retainer, a sun visor body may be rotated about a horizontal axis and arranged substantially centrally relative to the bearing block. Said sun visor may also be tilted from a position arranged parallel to the vehicle roof into a substantially vertical position and may be rotated about the vertical axis, such that it extends substantially in the direction of travel.

### SUMMARY OF THE INVENTION

It is the object of the invention to provide a fixing device for a vehicle for fixing a component, especially a sun visor, by means of which the component may be positioned very flexibly in the vehicle, may be adjusted in a great variety of ways and so that high comfort requirements of a user may be achieved.

The object is achieved by a fixing device for a vehicle for fixing a component, especially a sun visor, the fixing device comprising a cantilever arm which may be pivoted about a first, especially vertical rotational axis but is otherwise fixed in relation to the vehicle body, the component being able to be tilted in relation to the cantilever arm about a second, especially horizontal rotational axis, in addition to the fact that the component may be tilted about the second rotational axis, the component being provided so that the position thereof may be modified in relation to the cantilever arm.

The cantilever arm allows a flexible arrangement of the component in the vehicle, depending on the spatial conditions of the vehicle. When using the fixing device according to the invention for the fixing of a sun visor, the cantilever arm may, for example, be adapted to the spacing from the windshield and/or from a side window, the height of the vehicle roof and/or the inclination of the windshield.

An additional ability to modify the position in relation to the tiltability about the second rotational axis in the sense of the present invention is, for example, a linear displaceability along an axle or rod, or a rotatability of the component about a further (third) rotational axis. The additional ability to modify the position allows the mobility of the component in the vehicle to be very flexible. When using the fixing device for fixing a sun visor, said sun visor may, therefore, be adjusted very effectively as an antiglare device.

A component is, for example, a sun visor, a display or a lamp.

The component may be connected to a tilting arm fixed to the cantilever arm and which may be tilted relative thereto about the second rotational axis and is provided to be mobile relative to the tilting arm. The tilting arm allows a further adaptation of the fixing device to the spatial conditions of the vehicle. When using the fixing device for fixing a sun visor, the tilting arm allows, in particular, the adaptation to the height of the vehicle roof and/or the head height of the user.

In one embodiment, the component is provided to be longitudinally displaceable along the tilting arm, so that it may be displaced by the user himself/herself. The user may, therefore, adapt the component to his/her requirements, for example to his/her size. A user may adapt a sun visor fixed by means of the fixing device according to the invention to his/her eye level.

In a further embodiment, the component is provided to be rotatable relative to the tilting arm about a third rotational axis. The third rotational axis may be arranged substantially parallel to the second rotational axis, so that the tilting arm acts as an extension in the position of the component rotated about the third rotational axis, i.e. the folded up position. Moreover, the component may be provided to be able to be inclined (third rotational axis substantially in the direction of travel), for example by means of a ball-and-socket joint, so that the angle of the component relative to the tilting arm may be adjusted substantially in any manner.

The person skilled in the art understands that the fixing of the tilting arm to the cantilever arm is also possible by means of a ball-and-socket joint, so that the tilting arm may also be adjusted relative to the cantilever arm substantially at any angle.

The cantilever arm may comprise a retaining means and a carrier part. The retaining means can be arranged fixedly in terms of rotation in relation to the vehicle body, the carrier part being rotatable about the first rotational axis. Further the retaining means may be provided to be rotatable in relation to the vehicle body, the carrier part being arranged fixedly in terms of rotation on the retaining means.

The fastening device may be produced at least partially from a plastics material or metal. Further the carrier part and/or the tilting arm may comprise one or two struts. The struts can be produced from wire so that they may be produced very cost-effectively. In a similar embodiment, the tilting arm extends two-dimensionally, so that in turn it acts as a sun visor.

Particularly, the spacing between the first rotational axis and the second rotational axis may be altered so that the user may adapt it to himself/herself.

In one embodiment, the fixing device comprises a stop means which limits the ability to modify the position of the component, so that no positions may be set which make the operation of the component difficult or hinder the user. The operation of the component is, therefore, possible in a simple and reliable manner.

When using the fixing device for fixing a sun visor, the rotation of the cantilever arm about the first rotational axis may, in particular, be inhibited by means of the stop means, so that the sun visor may not be rotated by the user such that said sun visor is no longer able to be reached by the user during the journey.

Particularly, the stop means may comprise a sensor means. As a result, for example, the pivoting of the component about the first rotational axis may be detected. The adjustment of the component may be, therefore, for example at least partially automated or the adjustment of the component may be displayed.

Further, the pivoting, tilting, rotating or displacing of the component may be provided to be inhibited, so that the possible adjustment range of the component may be detected by the user and thus the operation of the component is more simple and more reliable.

The fixing device according to the invention may be used very flexibly and makes it possible for the user to be able to adjust a component, which is fixed by means of the fixing device, in a great variety of ways. By the ability to adjust said component in a variety of ways, said component may be positioned very flexibly and easily adapted to the spatial conditions in the vehicle. It may be easily operated and may be produced cost-effectively.

A further subject of the present invention is a component for a vehicle with a fixing device according to the invention, especially a sun visor. The component may be positioned very flexibly in the vehicle. Moreover, it may be adjusted very easily and in a variety of ways by the user.

### BRIEF DESCRIPTION OF THE DRAWINGS

The invention is described hereinafter with reference to the figures. The figures are merely by way of example and do not restrict the general inventive idea.

FIG. 1 shows schematically a fixing device according to the invention with a component in a perspective view.

FIG. 2 shows a side view of a basic shape of a fixing device according to the invention with a component.

FIG. 3 shows a side view of a further preferred embodiment of a fixing device with a component.

FIG. 4 shows a side view of a further preferred embodiment of a fixing device according to the invention with a component.

FIG. 5 shows side views of the fixing devices of the embodiments of FIGS. 3-5.

FIG. 6 shows schematically the fixing device according to the invention with a component and the rotatability thereof about the first rotational axis in a plan view, viewed from the vehicle roof in three positions.

FIG. 7 shows a perspective view of a fixing device according to the invention with a component, the tilting arm of the fixing device extending two-dimensionally.

### DETAILED DESCRIPTION OF THE PREFERRED EMBODIMENT

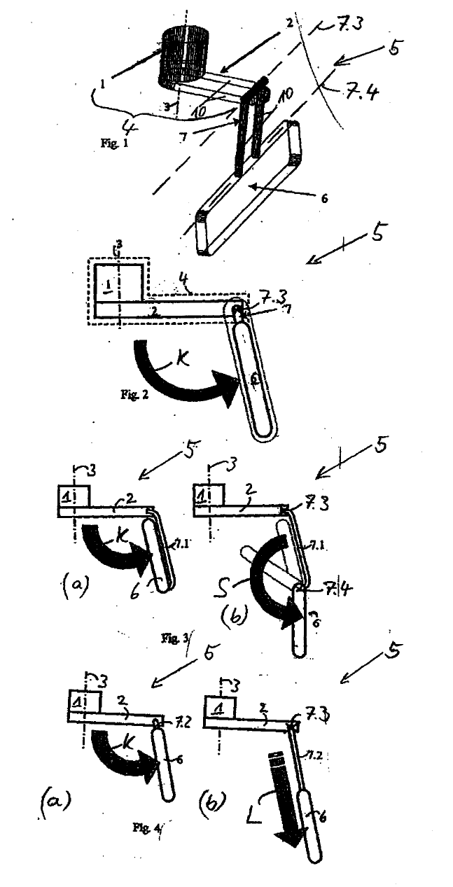

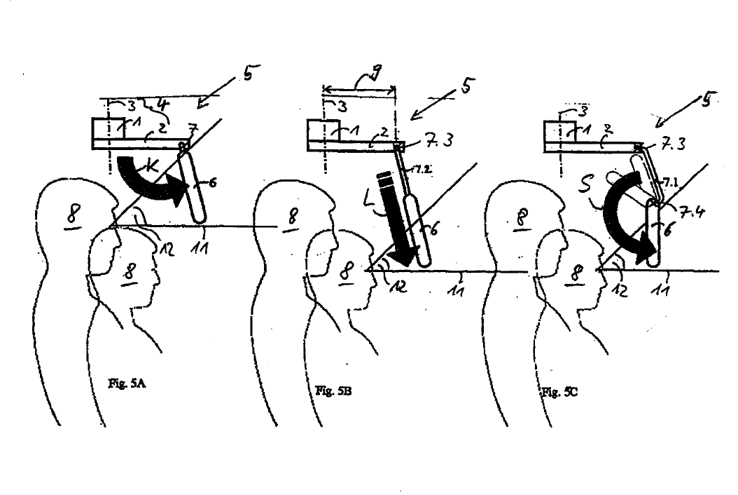

FIG. 1 shows schematically a fixing device 5 according to the invention with a component 6 in a perspective view. The fixing device 5 comprises a cantilever arm 4 which may be pivoted about a first, especially vertical rotational axis 3, which is otherwise fixed in relation to the vehicle body. The cantilever arm 4 comprises a retaining means 1 and a carrier part 2. The component 6 may be tilted in relation to the cantilever arm 4 about a second, especially horizontal, rotational axis 7.3. In addition to the fact that the component may be tilted about the second rotational axis 7.3, the component 6 is provided so that the position thereof may be modified relative to the cantilever arm 4. Said component is arranged on a tilting arm 7 fixed to the cantilever arm 4, the tilting arm 7 being tiltable relative to the cantilever arm 4 about the second rotational axis 7.3. Moreover, the component 6 may be arranged on the tilting arm 7, rotatable about a third rotational axis 7.4, the third rotational axis 7.4 being arranged, in particular, parallel to the second rotational axis 7.3, as shown by way of example in FIG. 1, or substantially vertically to the second rotational axis 3, as shown by way of example in FIG. 2, or at a different angle to the two rotational axes 3, 7.3.

The carrier part 2 and the tilting arm 7 comprise in this embodiment two respective struts 10.

FIG. 2 shows a side view of a basic shape of a fixing device 5 with a component 6. The fixing device 5 comprises the cantilever arm 4 which may be pivoted about the first rotational axis 3, with the retaining means 1 and the carrier part 2. The component 6 is tilted together with the tilting arm 7 about the second rotational axis 7.3, the tilting motion being indicated by means of an arrow K. An additional ability to modify the position of the component 6 is, in particular, provided, which provides a mobility of the component 6 in addition to the tilting of the component 6 about the second rotational axis 7.3.

The rotation about the first and second rotational axis 3, 7.3 takes place respectively in a reversible manner.

FIG. 3 shows a side view of a particularly preferred embodiment of a fixing device 5 according to the invention with a component 6. In contrast to FIG. 2, the tilting arm 7 is, in this case, provided as an extension 7.1 with two ends, the extension 7.1 being tiltably arranged on the one end on the carrier part 2 about the second rotational axis 7.3 and the component 6 on the other end being arranged rotatably about a third rotational axis 7.4, which extends substantially parallel to the second rotational axis 7.3. The rotation about the third rotational axis 7.4 also takes place in a reversible manner.

View a shows the component 6 after tilting the extension 7.1 about the second rotational axis 7.3, the tilting direction being shown by means of the arrow K.

View b shows the component 6 in a position additionally rotated about the third rotational axis 7.4, the rotational direction being shown by means of an arrow S.

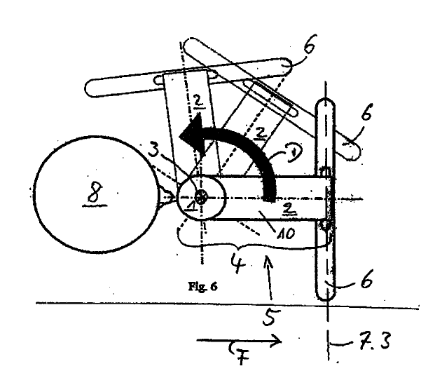

FIG. 4 shows a side view of a further preferred embodiment of a fixing device 5 according to the invention with a component 6. In contrast to the embodiment of FIG. 3 the tilting arm 7 of said embodiment is configured as a telescopic arm 7.2. In view a, the component 6 is tilted, in turn, about the second rotational axis 7.3, whilst it is additionally longitudinally displaced in view b. The displacement of the component 6 is shown by means of an arrow L. The component 6 may be pushed back in the opposite direction. In this embodiment, no third rotational axis 7.4 is provided.

FIG. 5 shows in views A-C, one respective side view of the fixing device 5 of the embodiments of FIG. 3-5, the component 6, in particular, being a sun visor. Hereinafter, therefore, the terms component 6 and sun visor are used synonymously.

The sun visor 6 with the fixing device 5 according to the invention may be folded up in the manner of a conventional sun visor about the second rotational axis 7.3.

The fixing device 5 according to the invention is preferably arranged above the head 8 of a person using a vehicle seat, not shown. The spacing 9 of the first rotational axis 3 from the second rotational axis 7.3 may be preferably but not necessarily adapted to the vehicle conditions and/or comfort requirements by the user, for example by altering the length of the carrier part 2. Thus the spacing 9, for example depending on the spacing of the fixing device 5 or the inclination of the windshields or side windows, may be adapted, as said spacing or inclination considerably varies in different types of motor vehicle, such as for example off-road vehicles or sedan vehicles.

By using a telescopic arm 7.2 as a tilting arm 7, as shown in view B, or an extension 7.1, as a tilting arm 7, as shown in view C, the height of the sun visor 6, which means the position of the sun visor in the Z-direction of a conventional vehicle coordinate system, may be adjusted such that the antiglare effect of the sun visor 6 is also ensured to be sufficient for a small person using the vehicle seat.

The view shows the viewing direction 11 and the antiglare angle 12 of a user. The sun visor 6 according to the invention may be adjusted by the user such that the viewing direction 11 of the user is not covered by the sun visor 6. At the same time, an optimal antiglare device is ensured.

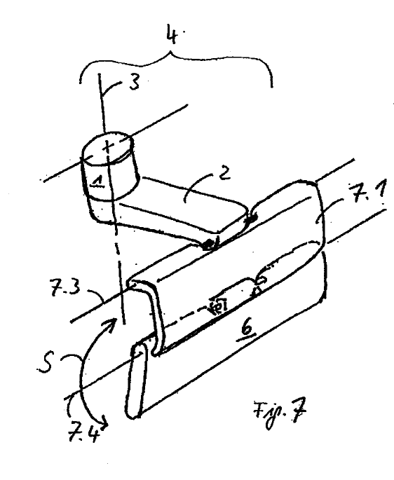

FIG. 6 shows schematically the sun visor 6 of FIG. 5 in the vehicle and the pivotability thereof about the first rotational axis 3 made possible by the fixing device 5, in a plan view, viewed from the vehicle roof in three positions. The view shows the sun visor 6 in a position tilted about the second rotational axis 7.3. The retaining means 1 is preferably arranged substantially centrally and in front of the head of the user, the carrier part 2 facing in the direction of travel F of the vehicle, so that the sun visor 6 is spaced apart from the retaining means 1 and from the head of the user. The direction of travel is indicated by means of an arrow F. By rotating the cantilever arm 4 about the first axis 3, the sun visor 6 may be pivoted such that an antiglare device is also possible against incident light to the side of the head. The pivoting about the first rotational axis 3 is shown by means of the arrow D.

The carrier part 2 shown in FIG. 6 comprises only one strut 10.

FIG. 7 shows a perspective view of a fixing device 5 according to the invention with a component 6, the tilting arm 7 of the fixing device 5 extending two-dimensionally. The tilting arm 7 thus acts in said embodiment not only as an extension 7.1 but it may at the same time be used as a sun visor. Moreover, a third rotational axis 7.4 is additionally provided substantially parallel to the second rotational axis 7.3, about which the sun visor 6 may be rotated when the extension 7.1 is tilted about the second rotational axis 7.3. The view shows the sun visor 6 in the position rotated about the third rotational axis 7.4. It may be seen that the antiglare surface is considerably increased by the two-dimensional continuation of the extension 7.1, so that the antiglare effect for a user is considerably improved.

The person skilled in the art understands that a tilting arm 7 configured as a telescopic arm 7.2, may also extend two-dimensionally, so that an extension of the telescopic arm 7.2 causes a continually enlarged antiglare surface.

The fixing device according to the invention with the sun visor 6 allows antiglare provision in all required positions, especially also with incident light in the region of the A-pillar of the vehicle. It is especially preferably used in vehicles with high wind shields and narrow rear transverse struts in the vehicle roof.

### LIST OF REFERENCE NUMERALS

1 Retaining means
2 Carrier part
3 First rotational axis
4 Cantilever arm
5 Fixing device
6 Component
7 Tilting arm
7.1 Extension
7.2 Telescopic arm
7.3 Second rotational axis
7.4 Third rotational axis
8 Head of a user
9 Spacing between the first rotational axis and the second rotational axis
10 Strut
11 Viewing direction
12 Antiglare angle

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

1. A fixing device (5) for a vehicle for mounting a moveable interior component (6), the fixing device (5) comprising:
a cantilever arm (4) pivoted about a first vertical rotational axis (3) but is otherwise fixed in relation to the vehicle body,
the component (6) being able to be tilted in relation to the cantilever arm (4) about a second horizontal rotational axis (7.3),
characterized in that, in addition to the component (6) being tiltable about the second rotational axis (7.3), the component (6) is provided so that the position thereof may be modified in relation to the cantilever arm (4).

2. The fixing device (5) as claimed in claim 1, further characterized in that the component (6) is connected to a tilting arm (7) fixed to the cantilever arm (4) and which may be tilted relative thereto about the second rotational axis (7.3), and is provided to be mobile relative to the tilting arm (7).

3. The fixing device (5) as claimed in claim 2, further characterized in that the component (6) is provided to be longitudinally displaceable along the tilting arm (7).

4. The fixing device (5) as claimed in claim 2, further characterized in that the component (6) is provided to be rotatable relative to the tilting arm (7) about a third rotational axis (7.4).

5. The fixing device (5) as claimed in claim 4, further characterized in that the third rotational axis (7.4) is arranged substantially parallel to the second rotational axis (7.3).

6. The fixing device (5) as claimed in claim 1, further characterized in that the cantilever arm (4) comprises a retaining means (1) and a carrier part (2).

7. The fixing device (5) as claimed in claim 1, further characterized in that the spacing (9) between the first rotational axis (3) and the second rotational axis (7.3) may be altered.

8. The fixing device (5) as claimed in claim 1, further characterized in that it comprises a stop means which limits the ability to modify the position of the component (6).

9. The fixing device (5) as claimed in claim 8, further characterized in that the stop means comprises a sensor means for detecting the inhibiting of the rotation of the cantilever arm (4) about the first rotational axis (3).

10. (canceled)

11. A fixing device (5) for a vehicle for mounting a moveable interior sun visor (6), the fixing device (5) comprising:
a cantilever arm (4) pivoted about a first vertical rotational axis (3) but is otherwise fixed in relation to the vehicle body,
the sun visor (6) being able to be tilted in relation to the cantilever arm (4) about a second horizontal rotational axis (7.3),
characterized in that, in addition to the sun visor (6) being tiltable about the second rotational axis (7.3), the sun visor (6) is provided so that the position thereof may be modified in relation to the cantilever arm (4).
